(19) United States
(12) Patent Application Publication
(10) Pub. No.: US 2012/0174869 A1
(43) Pub. Date: Jul. 12, 2012

(54) ELEMENT FOR PICKUP ANIMAL FECES

(75) Inventor: Erminio Walter Deppieri, Olmo Di Martellago (IT)

(73) Assignee: NEW TONES S.N.C. DI DEPPIERI E. & PARTNERS, Venezia (IT)

(21) Appl. No.: 13/394,748

(22) PCT Filed: Sep. 7, 2010
(86) PCT No.: PCT/EP10/63083

§ 371 Date: Mar. 7, 2012

(30) Foreign Application Priority Data
Sep. 8, 2009 (IT) UD2009U000017

(51) Int. Cl. A01K 29/00

(52) U.S. Cl. 119/161

(57) ABSTRACT

A collection element for animal feces including a container to contain the feces collected and a shovel to collect the feces and, in a completely closed position before being used, is pocket sized and flat in shape. The collection element for animal feces is made from a single sheet of rigid or semi-rigid paper, cardboard or other analogous or comparable material, shaped and foldable along a plurality of folding lines and suitably glued on a very limited part of its surface, wherein a part of the single sheet constitutes the container selectively closable on one side, and another part constitutes the shovel, separable, in use, from the single sheet and hence from the container, along a pre-cutting line.

### FIELD OF THE INVENTION

The present invention concerns an element for picking up animal feces.

In particular the present invention is preferentially applied in the city when pets, such as for example dogs, are taken for a walk on a lead, and it is necessary to pick up the feces of one's animals for reasons of cleanliness and civic duty and/or to avoid having to pay a fine.

### BACKGROUND OF THE INVENTION

It is known that domestic pets, such as for example dogs, need open spaces to live, to move freely, to run and play etc.

It is also known that, generally speaking, in the city there are few open spaces where pets can be left free, and often the only usable spaces are inside the house.

In such circumstances it is necessary to take one's pets for a walk on the lead through the city streets in order to let them stay in the open air.

In such cases it is necessary to have a container, during the walk, to pick up the feces of one's pets for reasons of cleanliness, civic duty and/or because in many cities fines are envisaged for those who do not trouble to clean the feces left by their animals from the streets, flowerbeds and other public spaces. Various solutions have been invented, from the simplest to some extremely complex, to allow dog owners to pick up the feces while avoiding, as far as possible, getting dirty.

For example a container is known, consisting of a bag made of light paper which, when it is not used, is folded up in the direction of the length into two or more parts; it has a flat shape, easily stacked, and in size it is bigger than a common wallet.

Glued on the edges of the opening, the bag has two fins of rigid material, having eyelets that the user can grip.

To use the known bag the user first has to unfold and open the bag, secondly to collect the animal feces using the fins which function as little shovels to push the feces inside the bag, placed open above the ground, thirdly to close the bag (which is done by making the two fins rotate completely until they are positioned one on top of the other), and fourthly to transport the bag to throw it in a rubbish container, using the eyelets made in the fins.

One disadvantage of this solution is that it is difficult to pick up the feces because the fins, attached to the bag, do not facilitate this operation.

Another disadvantage of this solution is that the bag cannot be used for sequential operations, since it must be disposed with the opening downward in order to be filled, and this causes any feces previously picked up to escape.

A solution is also known which provides to use a bag and a small shovel, made as separate pieces. In this way it is possible to use the same bag, if necessary, to pick up more than one deposit.

The bag has handles to facilitate transport, but it cannot be folded or stacked.

Another disadvantage of this solution is that it is not very practical because the separate shovel can get lost, thus making the bag unusable.

Purpose of the present invention is to provide a collection element that is in a single piece, easily transportable, which occupies little space and is therefore easy to store, and which is usable more than once, if necessary.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a collection element for animal feces according to the present invention comprises a container able to contain the feces collected and a shovel able to collect the feces and to thrust them inside the container. In its completely closed position, before being used, the collection element for animal feces is pocket-sized and flat.

According to a characteristic feature of the present invention, the collection element for animal feces is made from a single sheet, for example of rigid or semi-rigid paper, cardboard, or analogous or comparable material, shaped and foldable along a plurality of folding lines, which is suitably glued on a very limited part of its surface, wherein a part of the single sheet constitutes the container, closable on one side, and another part constitutes the shovel, and wherein the shovel, when it has to be used, is separable from the single sheet and hence from the container, along a pre-cutting line.

The element according to the invention has a packaged and transport condition in which it is completely folded over on itself, toward the inside, with a double fold, or window fold, so as to assume a pocket size. It also has a condition of use in which it is unfolded and opened, the shovel is detached from the container so as to be used, and the container is closed on one side so that during the collection, thanks to the size of the shovel and the fact that it is independent from the container, there is no risk of contact between the user's hands and the feces. The subsequent disposal of the collection element for animal feces in a rubbish container is very practical and easy.

According to a variant of the present invention, the collection element for animal feces comprises a closing face able to stiffen the container during the collection of the feces and to close the container after it has been used, so as to prevent any feces collected from escaping.

According to another variant, the closing face comprises a closing lip and an attachment end equipped with an eyelet. The eyelet cooperates with an attachment element present on the collection element for animal feces in order to keep the container closed during transport, after being used.

According to another variant, the attachment element is a tongue

According to another variant, the container is delimited laterally by two containing faces, partly glued to each other, and is closed at one end by two closing lips folded back along a folding line, which function as a bottom for the container.

According to another variant, the two closing lips have a convex free end and a concave folding line.

This makes the folding of the closing lips more secure because, even if they are subjected to the force of the weight of the feces collected, they keep their folded position.

According to another variant, the shovel has two gripping lips that can be lifted at the moment of use in order to facilitate gripping and to further reduce the risk of contact with the feces.

According to another variant, the containing face has the operations which have to be performed so as to collect the feces printed on it. This allows the user to perform correctly the operations to collect the animal feces using the collection element for animal feces according to the present invention.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a front view of a single sheet for the collection of animal feces in a completely folded position toward the inside and partly glued;

FIG. 2 is a view of the single sheet in FIG. 1 before being folded and partly glued;

FIGS. 3-10 show schematically in sequence the operations to be performed in order to collect animal feces with the single sheet in FIG. 1 according to the present invention.

### DETAILED DESCRIPTION OF A PREFERENTIAL FORM OF EMBODIMENT

With reference to FIG. 2, a collection element for animal feces 12 is a foldable single body made from a single sheet 10 of rigid or semi-rigid shaped cardboard, which provides a plurality of folding lines 19a, 19b, 19c, 19e, 19f, 19g, 19h and a pre-cutting line 18.

The single sheet 10 also comprises a shovel 11, two containing faces 22a and 22b and a closing face 13.

The closing face 13 in turn comprises an attachment end 21, equipped with an eyelet 16 and a closing lip 27, between which the folding line 19b is interposed.

Between the two containing faces 22a and 22b, which are substantially identical and adjacent, the folding line 19h is interposed.

By folding the single sheet 10 along the folding line 19h, the two elements 22a and 22b overlap perfectly and are constrained to each other at one end by means of a gluing fin 20 present on one end of the containing face 22b and foldable on the folding line 19e.

A gluing substance is deposited only on the surface of the fin 20 cooperating with the containing face 22a.

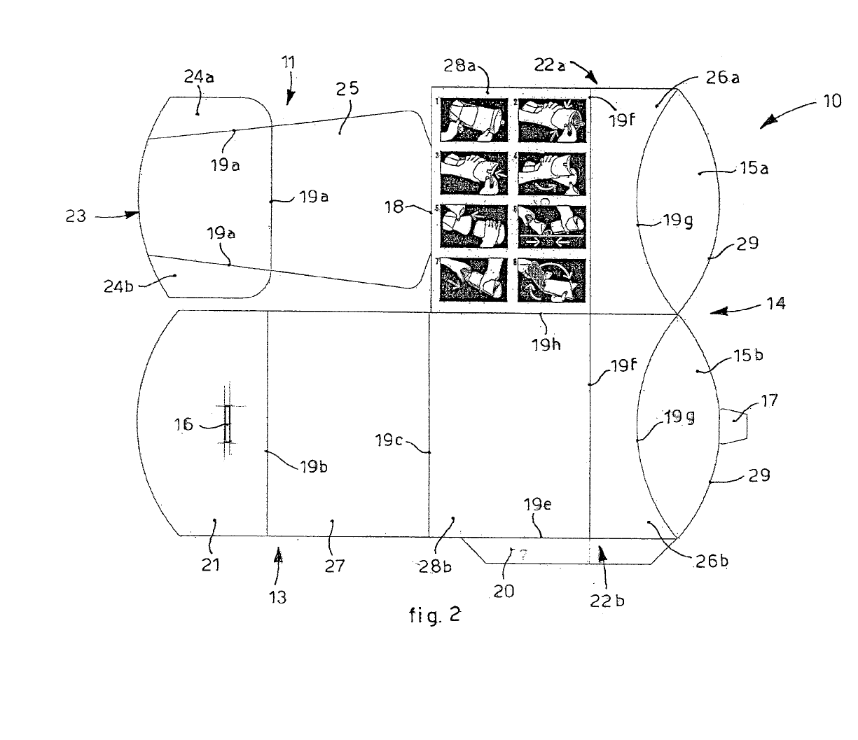

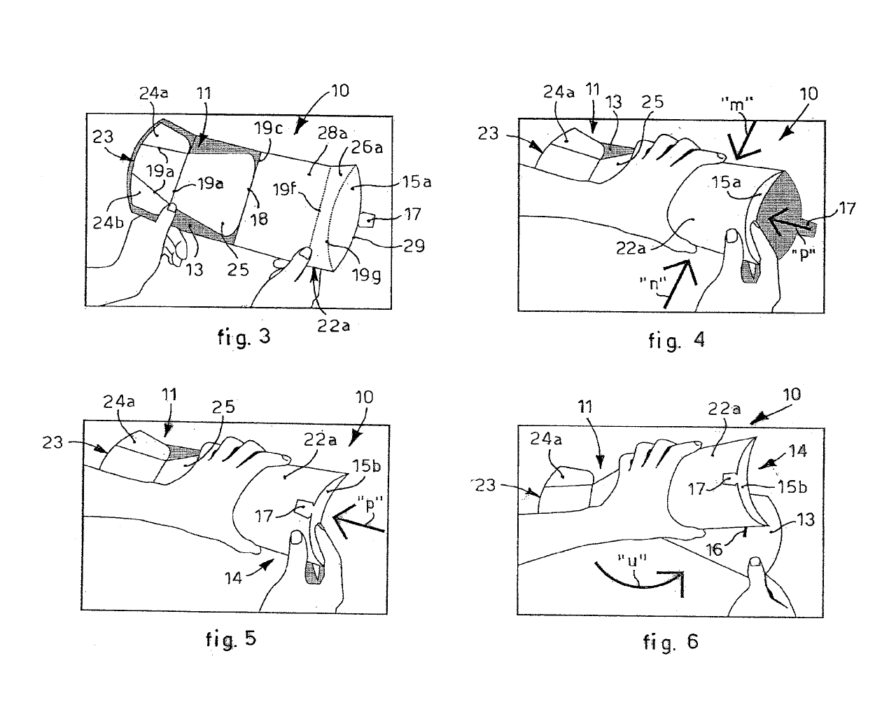

The shape assumed by the single sheet 10, unfolded, before use, is shown in FIG. 3.

By exerting a pressure both on the glued together ends in correspondence with the folding line 19e and also along the folding line 19h, the user defines a filling volume between the two containing faces 22a and 22b, as shown in FIG. 4.

The direction in which the pressure is exerted with the hands is shown by the arrows “m” and “n” in FIG. 4.

Each of the two containing faces 22a and 22b has a containing lip, respectively 28a and 28b, both identical, a folding and containing lip, respectively 26a and 26b, between which the folding line 19f is interposed, and a closing lip, respectively 15a and 15b.

The containing lip 28a has the instructions to be followed in order to collect the animal feces 12 with the collection element according to the present invention, in order to facilitate operations for the user.

Each closing lip 15a and 15b can be folded along the curved folding line 19g and has a slightly convex free end 29.

The closing lip 15b also comprises a tongue 17.

When both the closing lips 15a and 15b are folded by pressing with the hands on each of them in the direction indicated by the arrow “p” in FIGS. 4 and 5, a container 14 is achieved, delimited by the two containing faces 22a and 22b and closed at one end by the two closing lips 15a and 15b, which make up the bottom, and open at the other end, as shown in FIG. 8.

The animal feces 12 are collected and temporarily stored inside the container 14 during the use of the single sheet 10, in order to allow easy transport.

The two closing lips 15a and 15b are folded, leaving the tongue 17 outside the container 14.

The slight convexity of the end 29 makes the folding of the closing lips 15a and 15b more secure; even if they are subjected to the force of the weight of the feces 12 collected, they keep their folded position.

Furthermore, during the collection, the closing face 13 is folded back externally on the containing faces 22a and 22b, along the folding line 19c in the direction indicated by the arrow “u” in FIG. 6, so as not to impede the collection operation and to stiffen the cardboard.

The shovel 11 is used to push the animal feces 12 inside the filling volume created.

The shovel 11 has a handle 23 and a loading element 25.

The handle 23 is equipped with two liftable gripping lips 24a and 24b, so that they adhere to the user's hand when he grips the shovel 11, as shown in FIGS. 8 and 9. In this way, the hand does not come into contact with the feces and the shovel 11 can be easily gripped by the user.

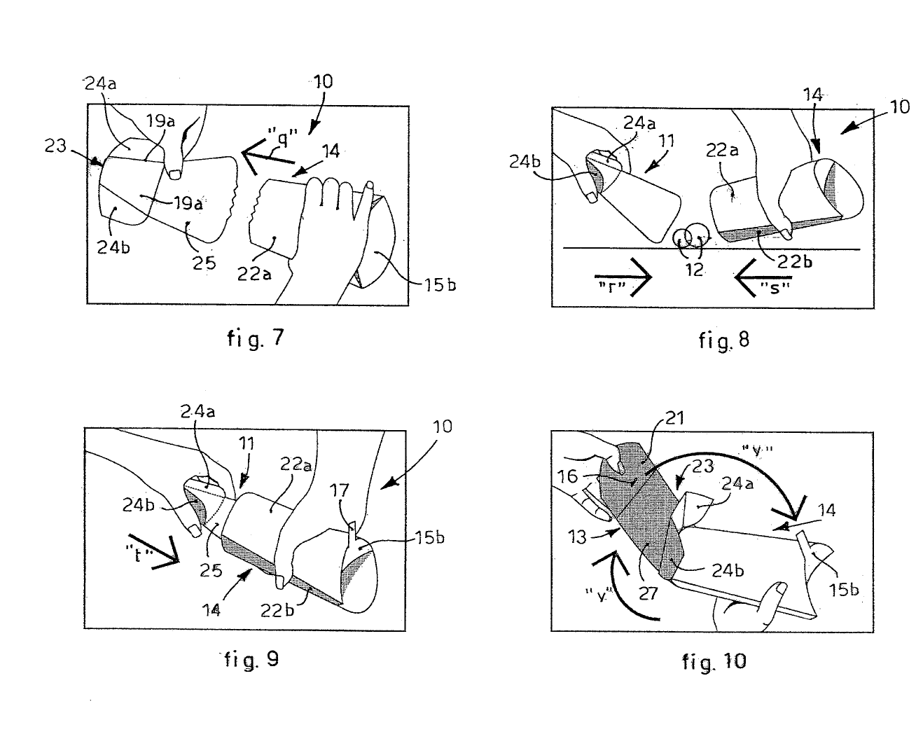

Furthermore, the shovel 11 is detachable, so as to be more easily usable, from the rest of the sheet 10 along the pre-cutting line 18, by pulling it in the direction indicated by the arrow “q” in FIG. 7.

In this way, once the shovel 11 has been detached for use, it is brought near so as to be in contact with the feces 12 to be picked up, in the direction indicated by the arrow “r” in FIG. 8. At the same time, the rest of the container 10 is also brought near the feces 12 in an opposite direction “s” and cooperates with the shovel 11 until the feces 12 are thrust onto the loading element 25 of the shovel 11.

After the animal feces 12 have been collected, the shovel 11 is inserted inside the container 14, in the direction indicated by the arrow “t” in FIG. 9, so as to release the feces 12 into the container 14.

At the end of the collection, the loading element 25 of the shovel 11 is left completely inside the volume defined by the two containing faces 22a and 22b, while the element 23 is made to protrude externally from the two containing faces 22a and 22b and released, so that it folds along the folding line 19a.

Furthermore, the open end of the container 14 is closed by folding the closing face 13 along the folding line 19c, in the direction indicated by the arrow “v” in FIG. 10, until the tongue 17 of the closing lip 15b is inserted inside the eyelet 16 present on the attachment end 21.

The folding line 19b also allows a further folding of the attachment end, to facilitate the closure of the container 14 once it is at least partly filled.

In this way it is possible to transport the container 14 easily, preventing the feces 12 from escaping.

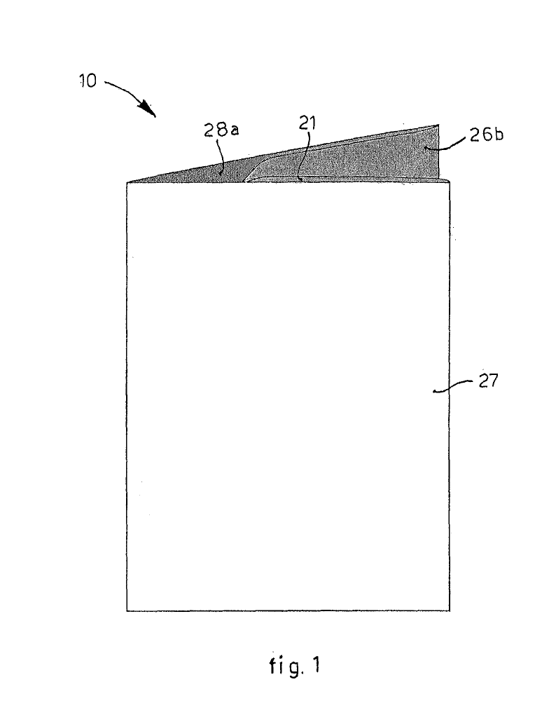

With reference to FIG. 1, the single sheet 10, in its folded form and almost completely closed, is prior to use. The shape of the sheet 10 in this case is flat and the sheet 10 is very small in size, just bigger than the standard size of a wallet.

In fact, the bulk of the single sheet 10 in its completely closed form is equal to the bulk of the containing lip 28a or 28b, indifferently, since the two lips are identical.

Folding occurs along the folding lines 19b, 19c and 19f shown in FIG. 2.

The folded form is useful, in particular, to allow the single sheet 10 to assume a pocket size form and to be easily transported by the user during his walks in the city with the domestic pet on the lead, for example directly inside a trouser pocket or elsewhere, or associated with a container, also small and easily transportable or even attachable to the lead.

Moreover, the single sheet 10 in its folded form can be easily stacked and packaged, due to its small size, allowing a considerable saving of space.

It is clear that modifications and/or additions of parts may be made to the collection element for animal feces as described heretofore, without departing from the field and scope of the present invention.

It is also clear that, although the present invention has been described with reference to some specific examples, a person of skill in the art shall certainly be able to achieve many other equivalent forms of container, having the characteristics as set forth in the claims and hence all coming within the field of protection defined thereby.

1. Collection element for animal feces, comprising a container able to contain the feces collected and a shovel able to collect the feces, said collection element, in a completely closed position before being used, being pocket sized and flat in shape,
wherein the collection element is made from a single sheet shaped and foldable along a plurality of folding lines and suitably glued on a very limited part of its surface,
wherein a part of the single sheet constitutes the container, selectively closable on one side, and another part constitutes the shovel, said shovel being separable, in use, from the single sheet and hence from the container along a pre-cutting line.

2. The collection element as in claim 1, wherein the collection element comprises a closing face able to stiffen the container during the collection of the feces and to close the container after use.

3. The collection element as in claim 2, wherein said closing face comprises a closing lip and an attachment end, equipped with an eyelet cooperating with an attachment element present on the collection element for animal feces.

4. The collection element as in claim 3, wherein said attachment element is a tongue.

5. The collection element as in claim 1, wherein the container is delimited laterally by two containing faces partly glued together, and is closed at one end by two closing lips folded along the folding line.

6. The collection element as in claim 5, wherein the two closing lips have a convex free end and a concave folding line.

7. The collection element as in claim 1, wherein the shovel has two raised gripping lips able to facilitate the gripping thereof and to reduce the risk of contact with the feces.

8. The collection element as in claim 5, wherein the containing face has the operations to be performed in order to collect the feces printed thereon.

9. The collection element as in claim 1, the single sheet comprising rigid or semi-rigid paper, cardboard or other analogous or comparable material.

10. The collection element as in claim 1, the single sheet comprising rigid or semi-rigid paper or cardboard.

11. The collection element as in claim 1, the single sheet comprising rigid or semi-rigid material.
